(19) United States
(12) Patent Application Publication
(10) Pub. No.: US 2025/0368456 A1
(43) Pub. Date: Dec. 4, 2025

(54) FLOW RATE ADJUSTMENT DEVICE

(71) Applicant: IHI Corporation, Tokyo (JP)

(72) Inventors: Zhihong LIU, Tokyo (JP); Atsushi ISHIKAWA, Tokyo (JP)

(73) Assignee: IHI Corporation, Tokyo (JP)

(21) Appl. No.: 19/246,134

(22) Filed: Jun. 23, 2025

Related U.S. Application Data
(63) Continuation of application No. PCT/JP2023/046963, filed on Dec. 27, 2023.

(30) Foreign Application Priority Data
Jan. 11, 2023 (JP) 2023-002554

(51) Int. Cl. B65G 53/66; B65G 53/52

(52) U.S. Cl. CPC B65G 53/66; B65G 53/521

(57) ABSTRACT

Provided is a flow rate adjustment device, including: a storage tank that allows solid particles to be stored in the storage tank; a delivery pipe, which penetrates a bottom surface of the storage tank, and has an upper end arranged in the storage tank; a through hole, which penetrates a side surface of the delivery pipe, and guides the solid particles stored in the storage tank into the delivery pipe; an inclined portion, which is provided at an upper end of the delivery pipe, and is inclined downward toward an inner wall of the storage tank; and a foreign-matter receiving portion, which is formed in a region of the bottom surface of the storage tank, the region facing an edge of a lower end of the inclined portion, and which is recessed downward.

### CROSS REFERENCE TO RELATED APPLICATIONS

This application is a continuation application of International Application No. PCT/JP2023/046963, filed on Dec. 27, 2023, which claims priority to Japanese Patent Application No. 2023-2554, filed on Jan. 11, 2023, the entire contents of which are incorporated by reference herein.

### BACKGROUND ART

### Technical Field

The present disclosure relates to a flow rate adjustment device.

As a device for adjusting a flow rate of solid particles, there has been disclosed a flow rate adjustment device including a storage tank, a pressurized gas line, a fluidizing gas line, and a delivery pipe (for example, Patent Literature 1). The storage tank stores solid particles. The pressurized gas line allows a pressurized gas to be supplied to an upper part of the storage tank. The fluidizing gas line allows a fluidizing gas to be supplied to a lower part of the storage tank. The delivery pipe is connected to the lower part of the storage tank. A mixture of fluidized powder and gas passes through the delivery pipe.

### CITATION LIST

### Patent Literature

Patent Literature 1: JP 2013-216402 A

### SUMMARY

### Technical Problem

In the technology for delivering the solid particles from the storage tank through the delivery pipe to an outside as described in Patent Literature 1, when foreign matter larger than each of the solid particles is present in the solid particles stored in the storage tank, there arises a problem in that the delivery pipe is clogged with the foreign matter. Thus, developing a technology for suppressing the clogging of the delivery pipe with the foreign matter has been desired.

The present disclosure has an object to provide a flow rate adjustment device capable of suppressing clogging of a delivery pipe with foreign matter.

### Solution to Problem

In order to solve the above-mentioned problem, according to one aspect of the present disclosure, there is provided a flow rate adjustment device, including: a storage tank that allows solid particles to be stored in the storage tank; a delivery pipe, which penetrates a bottom surface of the storage tank, and has an upper end arranged in the storage tank; a through hole, which penetrates a side surface of the delivery pipe, and guides the solid particles stored in the storage tank into the delivery pipe; an inclined portion, which is provided at an upper end of the delivery pipe, and is inclined downward toward an inner wall of the storage tank; and a foreign-matter receiving portion, which is formed in a region of the bottom surface of the storage tank, the region facing an edge of a lower end of the inclined portion, and which is recessed downward.

Further, the through hole may be inclined upward from an inner side of the delivery pipe toward an outer side of the delivery pipe.

Further, the inclined portion and the through hole may have such a relationship that an imaginary line corresponding to an upward extension of the center axis of the through hole passes through the inclined portion.

Further, the inclined portion may include: an apex portion arranged on a center axis of the delivery pipe; and an inclined surface being inclined downward from the apex portion toward a lower end.

### Effects

According to the present disclosure, clogging of the delivery pipe with foreign matter can be suppressed.

### BRIEF DESCRIPTION OF DRAWINGS

FIG. 1 is an explanatory view for illustrating a flow rate adjustment device according to this embodiment.

FIG. 2 is an explanatory first view for illustrating a state of solid particles at a sealing position.

FIG. 3 is an explanatory second view for illustrating a state of the solid particles at the sealing position.

FIG. 4 is an explanatory third view for illustrating a state of the solid particles at the sealing position.

FIG. 5 is an explanatory view for illustrating a state of the solid particles at a retreat position.

FIG. 6 is an explanatory view for illustrating an inclined portion in this embodiment.

FIG. 7 is an explanatory view for illustrating a relationship between the inclined portion and through holes.

### DESCRIPTION OF EMBODIMENTS

Now, with reference to the attached drawings, an embodiment of the present disclosure is described in detail. The dimensions, materials, specific numerical values, and the like represented in the embodiment are merely examples used for facilitating the understanding of the disclosure, and do not limit the present disclosure unless otherwise particularly noted. Elements having substantially the same functions and configurations herein and in the drawings are denoted by the same reference symbols to omit redundant description thereof. Further, illustration of elements with no direct relationship to the present disclosure is omitted.

### [Flow Rate Adjustment Device 100]

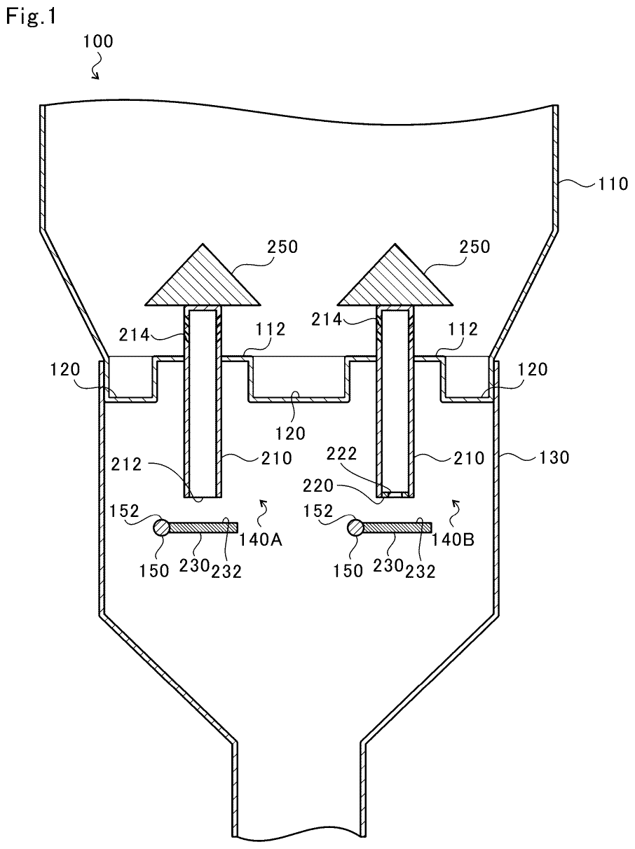

FIG. 1 is an explanatory view for illustrating a flow rate adjustment device 100 according to this embodiment. As illustrated in FIG. 1, the flow rate adjustment device 100 includes a storage tank 110, foreign-matter receiving portions 120, a collection tank 130, a plurality of adjustment units 140A and 140B, moving units 150, and inclined portions 250. In FIG. 1, illustration of solid particles and foreign matter is omitted for easy understanding.

The flow rate adjustment device 100 adjusts a flow rate of solid particles flowing downward from its upper side. In this embodiment, the flow rate adjustment device 100 adjusts a flow rate of solid particles flowing from the storage tank 110 into the collection tank 130. Examples of the solid particles (powder) include: minerals such as silica, alumina, barite sand (barite, barium sulfate), and olivine; partially calcined clay; glass beads; and a recovered petroleum catalyst. A particle diameter of each of the solid particles is, for example, 0.01 mm or more and 10 mm or less. A shape of each of the solid particles is not limited, and may be spherical or non-spherical.

The storage tank 110 stores the solid particles. Further, a part of each of delivery pipes 210 described later and the inclined portions 250 are arranged in the storage tank 110. In the storage tank 110, a part of each of the delivery pipes 210 and the inclined portions 250 are buried in the solid particles.

The foreign-matter receiving portions 120 are each a portion that is recessed downward from a bottom surface 112 of the storage tank 110. The foreign-matter receiving portions 120 are described later in detail.

The collection tank 130 is a tubular member extending in a vertical direction. In the collection tank 130, the bottom surface 112 of the storage tank 110, the foreign-matter receiving portions 120, a part of each of the delivery pipes 210 described later, sealing plates 230 described later, and the moving units 150 described later are arranged.

The adjustment units 140A and 140B each include the delivery pipe 210 and the sealing plate 230.

The delivery pipe 210 is a pipe that extends in the vertical direction and penetrates the bottom surface 112 of the storage tank 110. An inner diameter of the delivery pipe 210 is substantially constant. In this embodiment, a flow passage sectional area of the delivery pipe 210 of the adjustment unit 140A and a flow passage sectional area of the delivery pipe 210 of the adjustment unit 140B are substantially equal to each other.

An upper end of the delivery pipe 210 is arranged inside the storage tank 110. An upper end (upper opening) of the delivery pipe 210 is sealed. A lower end of the delivery pipe 210 is arranged in the collection tank 130. The lower end of the delivery pipe 210 is opened. That is, a lower opening 212 is formed at the lower end of the delivery pipe 210.

Further, an orifice plate 220 is provided in the delivery pipe 210 of the adjustment unit 140B out of the delivery pipes 210. An opening 222 is formed in the orifice plate 220. An area of the opening 222 is smaller than an area of the lower opening 212 (flow passage sectional area of the delivery pipe 210). The area of the opening 222 is, for example, half the area of the lower opening 212 of the delivery pipe 210.

One or a plurality of through holes 214 are formed in a part of a side surface of each of the delivery pipes 210, which is located inside the storage tank 110. The through holes 214 penetrate the side surface of each of the delivery pipes 210. The through holes 214 guide the solid particles stored in the storage tank 110 into the delivery pipes 210.

For example, an aperture diameter of an opening of each of the through holes 214 is seven times or more the particle diameter of the solid particle, and is less than a diameter of the opening 222 of the orifice plate 220. It is appropriate that a sum of the areas of the openings of the through holes 214 be larger than the area of the lower opening 212.

The through holes 214 are each inclined upward from an inner side of the delivery pipe 210 toward its outer side. It is appropriate that an inclination angle of each of the through holes 214 with respect to a center axis of the delivery pipe 210 be larger than an angle of repose.

The solid particles stored in the storage tank 110 are guided into the delivery pipes 210 through the through holes 214 of the delivery pipes 210, fall down inside the delivery pipes 210, and pass through the lower openings 212 of the delivery pipes 210 to fall down into the collection tank 130.

As described above, the orifice plate 220 is not provided inside the delivery pipe 210 of the adjustment unit 140A, while the orifice plate 220 is provided inside the delivery pipe 210 of the adjustment unit 140B. Further, the area of the opening 222 of the orifice plate 220 is smaller than the area of the lower opening 212 of the delivery pipe 210. Thus, a flow rate of the solid particles delivered from the delivery pipe 210 of the adjustment unit 140A into the collection tank 130 is different from a flow rate of the solid particles delivered from the delivery pipe 210 of the adjustment unit 140B into the collection tank 130. For example, in a case in which the area of the opening 222 is half the area of the lower opening 212, when the flow rate of the solid particles through the delivery pipe 210 of the adjustment unit 140A is defined as 1, the flow rate of the solid particles through the delivery pipe 210 of the adjustment unit 140B is ½.

The sealing plates 230 are provided below the lower openings 212 of the delivery pipes 210, respectively. Each of the sealing plates 230 has a sealing surface 232. When the sealing plate 230 is at a sealing position described later, the sealing surface 232 extends in a substantially horizontal direction.

The moving unit 150 moves the sealing plate 230 between the sealing position and a retreat position. The sealing position is a position at which the sealing surface 232 of the sealing plate 230 is positioned vertically below the lower opening 212 of the delivery pipe 210. In the example illustrated in FIG. 1, the sealing plates 230 of the adjustment unit 140A and the adjustment unit 140B are arranged at the sealing positions, respectively.

The moving units 150 move the sealing plate 230 of the adjustment unit 140A and the sealing plate 230 of the adjustment unit 140B independently of each other, respectively.

In this embodiment, each of the moving units 150 rotates the sealing plate 230 in an up-and-down direction to thereby move the sealing plate 230 between the sealing position and the retreat position. The moving unit 150 includes, for example, a rotation shaft 152 and an actuator (not shown). The rotation shaft 152 is provided at one end of the sealing plate 230. The rotation shaft 152 extends in a horizontal direction or a substantially horizontal direction.

The actuator rotates the rotation shaft 152. The actuator includes, for example, a motor. The actuator may be provided in the collection tank 130 or outside the collection tank 130. When the solid particles have a high temperature (for example, 500° C. or higher), the actuator may be cooled (for example, cooled with water).

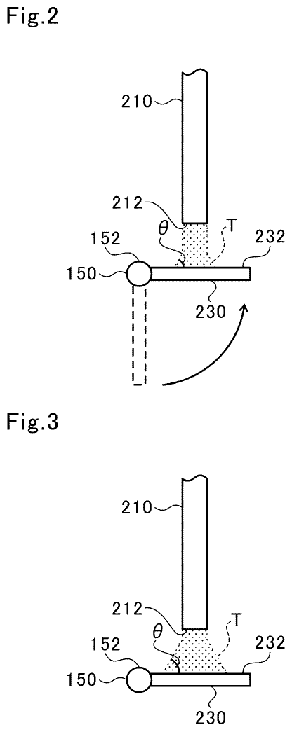

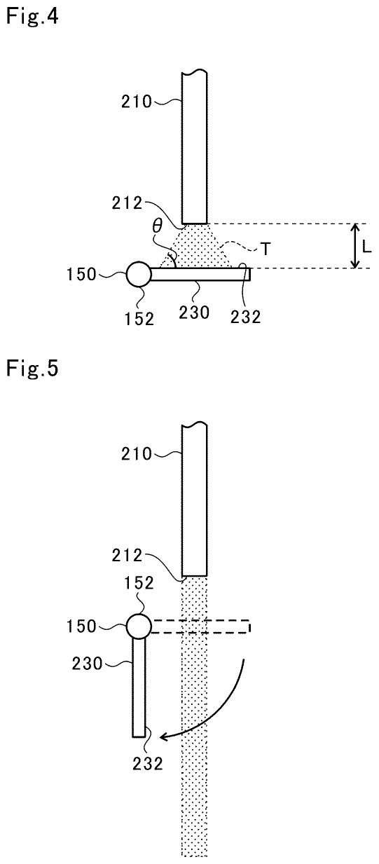

FIG. 2 is an explanatory first view for illustrating a state of the solid particles at the sealing position. FIG. 3 is an explanatory second view for illustrating a state of the solid particles at the sealing position. FIG. 4 is an explanatory third view for illustrating a state of the solid particles at the sealing position.

As illustrated in FIG. 2, when the sealing plate 230 is moved from the retreat position to the sealing position (indicated by the arrow in FIG. 2), the solid particles flowing down from the lower opening 212 of the delivery pipe 210 are deposited on the sealing plate 230. The deposited solid particles form a conical shape while maintaining an angle of repose θ. The angle of repose θ is an angle formed by a slope of the conical shape and the sealing surface 232.

The solid particles continue flowing down from the lower opening 212. Thus, as illustrated in FIG. 3, the solid particles are deposited (pile up) on the sealing plate 230 while maintaining the angle of repose θ. A deposit T having a conical shape, which is formed of the solid particles, becomes larger as elapsed time after switching from the retreat position to the sealing position becomes longer. That is, as the elapsed time becomes longer, a contact area (size of a bottom surface of the deposit T) between the deposit T and the sealing surface 232 becomes larger.

Then, when a top of the deposit T reaches the lower opening 212 and the lower opening 212 is closed with the deposit T as illustrated in FIG. 4, the lower opening 212 is sealed with the deposit T. In this manner, the fall of the solid particles from the lower opening 212 is stopped.

That is, when the sealing plate 230 is positioned at the sealing position, a flow of the solid particles from the delivery pipe 210 can be stopped.

A distance L (shortest distance) between the lower opening 212 and the sealing surface 232 at the sealing position is equal to or more than a maximum particle diameter of the solid particles. The distance L is, for example, about ten times or more the particle diameter (for example, the maximum particle diameter) of the solid particle. When the distance L is excessively small, the lower opening 212 and the sealing surface 232 may slide against each other and become worn. Thus, when the distance L is set to be equal to or more than the maximum particle diameter of the solid particle, the wear of the lower opening 212 and the sealing surface 232 can be prevented.

Further, a maximum value of the distance L is determined based on a size of the sealing surface 232. More specifically, the distance L is a value that allows an area of a bottom surface of the deposit T to have a value less than the area of the sealing surface 232 at the time when the lower opening 212 is closed with the deposit T.

FIG. 5 is an explanatory view for illustrating a state of the solid particles at the retreat position. As illustrated in FIG. 5, when the sealing plate 230 is moved from the sealing position to the retreat position (indicated by the arrow in FIG. 5), the deposit T formed on the sealing surface 232 of the sealing plate 230 falls down into the collection tank 130 to thereby cancel the sealing of the lower opening 212 with the deposit T. In this manner, the solid particles restart falling down through the delivery pipe 210 (lower opening 212).

As described above, when the moving units 150 merely move any one or both of the sealing plates 230 of the adjustment unit 140A and the adjustment unit 140B, which have outlets (the lower opening 212 and the opening 222) of different sizes for the solid particles, from the sealing position to the retreat position, the flow rate of the solid particles supplied from the storage tank 110 into the collection tank 130 can be adjusted. Further, when the moving units 150 position both of the sealing plates 230 of the adjustment unit 140A and the adjustment unit 140B at the sealing positions, respectively, the supply of the solid particles from the storage tank 110 into the collection tank 130 can be stopped. Further, the sealing plate 230 is merely moved to the sealing position or the retreat position. Thus, the flow rate adjustment device 100 can adjust the flow rate of the solid particles having a high temperature of 500° C. or higher.

When foreign matter larger than the solid particle is present in the solid particles stored in the storage tank 110, the through holes 214, the lower opening 212, or the opening 222 may be clogged with the foreign matter. In view of the foregoing, the flow rate adjustment device 100 according to this embodiment includes the inclined portions 250.

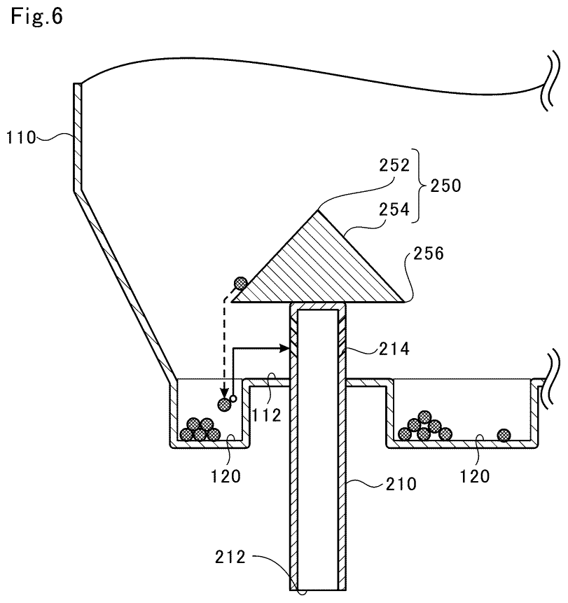

FIG. 6 is an explanatory view for illustrating the inclined portion 250 in this embodiment. In FIG. 6, an open circle represents the solid particle. In FIG. 6, the crosshatched circles represent the foreign matter. In FIG. 6, the solid arrow indicates the flow of the solid particles expelled from the foreign-matter receiving portion 120. In FIG. 6, the broken arrow indicates a flow of the foreign matter guided into the foreign-matter receiving portion 120 along an inclined surface 254.

As illustrated in FIG. 6, the inclined portion 250 is provided at an upper end of the delivery pipe 210. In this embodiment, the inclined portion 250 has a conical shape. That is, the inclined portion 250 includes an apex portion 252 and the inclined surface 254. The apex portion 252 of the inclined portion 250 is arranged on the center axis of the delivery pipe 210. The inclined surface 254 is a surface that is inclined downward from the apex portion 252 toward its lower end.

The foreign-matter receiving portion 120 is formed in a region of the bottom surface 112 of the storage tank 110, which faces an edge 256 of a lower end of the inclined portion 250 (lower end of the inclined surface 254). That is, the foreign-matter receiving portion 120 is formed in the region of the bottom surface 112 of the storage tank 110, which includes a position opposed to the edge 256 of the lower end of the inclined portion 250. The foreign-matter receiving portion 120 is formed in the region of the bottom surface 112 of the storage tank 110, at least at the position opposed to the edge 256 of the lower end of the inclined portion 250 and on an outer side of the inclined portion 250 (outer side of the delivery pipe 210) with respect to the opposed position. The foreign-matter receiving portion 120 is formed below the through holes 214 of the delivery pipe 210.

As described above, a part of each of the delivery pipes 210 and the inclined portions 250 are buried in the solid particles inside the storage tank 110. Further, the foreign-matter receiving portions 120 are also filled with the solid particles.

Here, when the sealing plate 230 is located at the retreat position, the solid particles inside the storage tank 110 move into the collection tank 130 through the delivery pipe 210 (the through holes 214 and the lower opening 212). Thus, the solid particles inside the storage tank 110 move downward. Further, the foreign matter in the solid particles also moves downward along with the movement of the solid particles. At this time, the solid particles and the foreign matter that have collided against the inclined surface 254 of the inclined portion 250 move downward along the inclined surface 254.

As described above, the foreign-matter receiving portion 120 is formed in the region facing the edge 256 of the lower end of the inclined surface 254. Thus, the solid particles and the foreign matter that have moved to the lower end of the inclined surface 254 move downward and are guided into the foreign-matter receiving portion 120. As a result, the solid particles and the foreign matter are received in the foreign-matter receiving portion 120.

The foreign matter has a particle diameter larger than that of the solid particle. Thus, when the foreign matter is guided by the inclined portion 250 into the foreign-matter receiving portions 120 as indicated by the broken arrow in FIG. 6, the solid particles in the foreign-matter receiving portion 120 are expelled into the storage tank 110 as indicated by the solid arrow in FIG. 6. Accordingly, the foreign matter is stored in priority to the solid particles in the foreign-matter receiving portion 120. The foreign matter in the foreign-matter receiving portion 120 is discharged to the outside by a screw feeder (not shown) or the like.

As described above, the flow rate adjustment device 100 according to this embodiment includes the inclined portions 250 and the foreign-matter receiving portions 120. Thus, the flow rate adjustment device 100 can guide the foreign matter in the solid particles into the foreign-matter receiving portions 120. Accordingly, the flow rate adjustment device 100 can suppress the movement of the foreign matter to the through holes 214, and hence can suppress the clogging of the through holes 214 with the foreign matter.

Meanwhile, the solid particle expelled by the foreign matter from the foreign-matter receiving portion 120 into the storage tank 110 as indicated by the solid arrow in FIG. 6 passes through the through hole 214 and is guided into the delivery pipe 210.

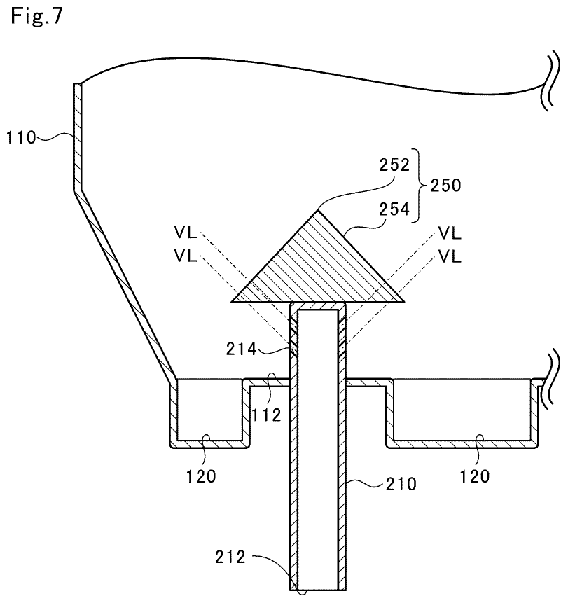

FIG. 7 is an explanatory view for illustrating a relationship between the inclined portion 250 and the through holes 214. As illustrated in FIG. 7, in this embodiment, the inclined portion 250 and the through holes 214 have such a relationship that imaginary lines VL corresponding to upward extensions of center axes of the through holes 214 pass through the inclined portion 250.

This relationship allows the foreign matter, which has moved to the lower end of the inclined surface 254, from moving directly to the through holes 214. Thus, the flow rate adjustment device 100 can further suppress the movement of the foreign matter to the through holes 214.

As described above, the flow rate adjustment device 100 according to this embodiment includes the inclined portions 250 and the foreign-matter receiving portions 120. As a result, the flow rate adjustment device 100 can suppress the clogging of the delivery pipes 210 (through holes 214) with the foreign matter.

Further, as described above, the through holes 214 are inclined upward from the inner side of the delivery pipe 210 toward its outer side. Thus, the through holes 214 can smoothly guide the solid particles into the delivery pipe 210. Thus, the clogging of the through holes 214 with the solid particles can be suppressed.

Further, as described above, each of the inclined portions 250 includes: the apex portion 252 arranged on the center axis of the delivery pipe 210; and the inclined surface 254 inclined downward from the apex portion 252 toward the lower end. As a result, even when the plurality of through holes 214 are opposed to each other in the delivery pipe 210, the clogging of the through holes 214 with the solid particles can be suppressed.

The embodiment has been described above with reference to the attached drawings, but, needless to say, the present disclosure is not limited to the embodiment. It is apparent that those skilled in the art may arrive at various alternations and modifications within the scope of claims, and those examples are construed as naturally falling within the technical scope of the present disclosure.

For example, in this embodiment, description has been given as an example of the case in which the flow rate adjustment device 100 includes the plurality of adjustment units 140A and 140B. However, the flow rate adjustment device 100 may include only one adjustment unit. In this case, the flow rate adjustment device 100 functions as an on-off valve that switches on and off the flow of the solid particles.

Further, in this embodiment, description has been given as an example of the case in which the inner diameter of the delivery pipe 210 of the adjustment unit 140A and the inner diameter of the delivery pipe 210 of the adjustment unit 140B are substantially equal to each other, and the orifice plate 220 is provided only in the delivery pipe 210 of the adjustment unit 140B. However, the inner diameter of the delivery pipe 210 of the adjustment unit 140A and the inner diameter of the delivery pipe 210 of the adjustment unit 140B may be different from each other. Further, the adjustment units 140A and 140B may be different from each other in at least a part of the flow passage sectional area of the delivery pipe 210. The adjustment units 140A and 140B may be different from each other in the inner diameter of a narrowest portion of the delivery pipe 210.

Further, in this embodiment, description has been given as an example of the case in which the delivery pipes 210 are pipes extending in the vertical direction. However, the delivery pipes 210 may be inclined.

Further, in this embodiment, description has been given as an example of the case in which the moving units 150 rotate the sealing plate 230. However, a direction of movement of the sealing plate 230 is not limited as long as the moving unit 150 can move the sealing plate 230 between the sealing position and the retreat position. For example, the moving unit 150 may linearly move the sealing plate 230 in the horizontal direction.

Further, in this embodiment, description has been given as an example of the case in which the moving units 150 each rotate the sealing plate 230 in the up-and-down direction. However, each of the moving units 150 may rotate the sealing plate 230 in a substantially horizontal direction. In this case, the rotation shaft extends in a substantially vertical direction. In any case, it suffices as long as the moving unit 150 can move the sealing plate 230 between the sealing position and the retreat position.

Further, in this embodiment, description has been given as an example of the case in which the through holes 214 are inclined upward from the inner side of the delivery pipe 210 toward its outer side. However, the through holes 214 may extend in the horizontal direction.

Further, in this embodiment, description has been given as an example of the case in which the inclined portion 250 and the through holes 214 have such a relationship that the imaginary lines VL corresponding to the upward extensions of the center axes of the through holes 214 pass through the inclined portion 250. However, the inclined portion 250 and the through holes 214 may have such a relationship that the imaginary lines VL corresponding to the upward extensions of the center axes of the through holes 214 do not pass through the inclined portion 250.

Further, in this embodiment, description has been given as an example of the case in which the inclined portion 250 has a conical shape. However, the shape of the inclined portion 250 is not limited as long as the inclined portion 250 has a shape inclined downward toward an inner wall of the storage tank 110. The inclined portion 250 may have, for example, a shape such as a semispherical shape or a polygonal pyramid shape, which has an apex portion and an inclined surface being inclined downward from the apex portion toward a lower end. Further, the inclined portion 250 may be a flat plate having an inclined surface that is inclined downward toward the inner wall of the storage tank 110. Further, the inclined portion 250 may have a spherical shape.

What is claimed is:

1. A flow rate adjustment device, comprising:
a storage tank that allows solid particles to be stored in the storage tank;
a delivery pipe, which penetrates a bottom surface of the storage tank, and has an upper end arranged in the storage tank;
a through hole, which penetrates a side surface of the delivery pipe, and guides the solid particles stored in the storage tank into the delivery pipe;
an inclined portion, which is provided at an upper end of the delivery pipe, and is inclined downward toward an inner wall of the storage tank; and
a foreign-matter receiving portion, which is formed in a region of the bottom surface of the storage tank, the region facing an edge of a lower end of the inclined portion, and which is recessed downward.

2. The flow rate adjustment device according to claim 1, wherein the through hole is inclined upward from an inner side of the delivery pipe toward an outer side of the delivery pipe.

3. The flow rate adjustment device according to claim 2, wherein the inclined portion and the through hole have such a relationship that an imaginary line corresponding to an upward extension of the center axis of the through hole passes through the inclined portion.

4. The flow rate adjustment device according to claim 1, wherein the inclined portion includes:
an apex portion arranged on a center axis of the delivery pipe; and
an inclined surface being inclined downward from the apex portion toward a lower end.
